(19) United States
(12) Patent Application Publication
(10) Pub. No.: US 2025/0309221 A1
(43) Pub. Date: Oct. 2, 2025

(54) COATING METHOD, SLURRY COMPOSITION, AND COATER

(71) Applicant: HONDA MOTOR CO., LTD., Tokyo (JP)

(72) Inventors: Koei FUJIKI, Saitama (JP); Atsushi OGAWA, Saitama (JP)

(21) Appl. No.: 19/063,804

(22) Filed: Feb. 26, 2025

(30) Foreign Application Priority Data
Mar. 30, 2024 (JP) 2024-058318

(51) Int. Cl. H01M 4/04; H01M 4/02; H01M 4/62; H01M 10/0525; H01M 10/0562

(52) U.S. Cl. CPC H01M 4/0404; H01M 4/622; H01M 4/625; H01M 10/0525; H01M 10/0562; H01M 2004/021; H01M 2004/028; H01M 2300/0068

(57) ABSTRACT

The present invention provides a coating method, a slurry composition, and a coater that are able to facilitate application at high coating speed. The coating method includes applying the slurry composition to a substrate by discharging the slurry composition from an outlet of a discharger with the discharger and the substrate moving relative to each other. The concentration of solid contents relative to the total amount of the slurry composition is in a range of 70 mass % to 90 mass %. A capillary number obtained by dividing a product of a viscosity and coating speed of the slurry composition by a surface tension of the slurry composition is in a range of one to five. A value obtained by dividing a coating thickness of the slurry composition by a bead gap which is a distance between the outlet and the substrate is greater than ⅔ and less than one.

This application is based on and claims the benefit of priority from This application is based on and claims the benefit of priority from Japanese Patent Application No. 2024-058318, filed on 30 Mar. 2024, the content of which is incorporated herein by reference.

### BACKGROUND OF THE INVENTION

### Field of the Invention

The present invention relates to a coating method, a slurry composition, and a coater.

### Related Art

Research and development of secondary batteries that contribute to improvement of energy efficiency is underway for more people to have access to reasonable, reliable, sustainable, and advanced energy.

Production of the secondary batteries include a process of forming an electrode by coating a sheet-shaped substrate with a slurry containing an active material. The slurry is applied using an intermittent coater as described in, for example, Patent Document 1. The intermittent coater continuously conveys the substrate and intermittently discharges the slurry to the substrate. Thus, the slurry is applied at intervals to the substrate.
Patent Document 1: Japanese Unexamined Patent Application, Publication No. 2001-038276

### SUMMARY OF THE INVENTION

When the slurry is applied at high speed, there is concern that a coating defect may occur, such as an uneven thickness of the applied slurry and an irregular coating surface. Thus, there is yet room for improvement in ease of application of the slurry in the high speed coating of the slurry.

An object of the present invention is to provide a coating method, a slurry composition, and a coater that are able to facilitate the application at high coating speed.

In a first aspect, the present invention is directed to a coating method for applying a slurry composition containing a positive electrode active material, a conductive agent, a binder, and a solvent. The method includes: applying the slurry composition to a substrate by discharging the slurry composition from an outlet of a discharger for discharging the slurry composition with the discharger and the substrate moving relative to each other. A concentration of solid contents relative to the total amount of the slurry composition is in a range of 70 mass % to 90 mass %. A capillary number obtained by dividing a product of a viscosity (Pa·s) and coating speed (m/s) of the slurry composition by a surface tension (N·m) of the slurry composition is in a range of one to five, and a value obtained by dividing a coating thickness of the slurry composition by a bead gap which is a distance between the outlet and the substrate is greater than ⅔ and less than one.

The coating method of the first aspect can reduce a coating defect such as an uneven thickness of the slurry discharged from the coater and an irregular coating surface of the slurry. Thus, the present invention can provide a coating method that can facilitate application at high coating speed.

According to a second aspect, in the coating method of the first aspect, the bead gap may be greater than 200 μm and less than 300 μm.

The coating method according to the second aspect can further facilitate the application at high coating speed.

According to a third aspect, in the coating method of the first or second aspect, the coating thickness may be in a range of 100 μm to 200 μm.

The coating method according to the third aspect can further facilitate the application at high coating speed.

According to a fourth aspect, in the coating method of any one of the first to third aspects, the coating speed of the slurry composition may be in a range of 0.83 m/s to 1.17 m/s.

The coating method according to the fourth aspect can further facilitate the application at high coating speed.

A fifth aspect is directed to the slurry composition used in the coating method of any one of the first to fourth aspects, wherein the slurry composition contains a solid electrolyte.

The slurry composition of the fifth aspect can facilitate the application at high coating speed.

According to a sixth aspect, the slurry composition of the fifth aspect contains 60 mass % to 85 mass % of the positive electrode active material, 1 mass % to 3 mass % of the conductive agent, 10 mass % to 38 mass % of the solid electrolyte, and 0.5 mass % to 5 mass % of the binder, relative to the total solid contents in the slurry composition.

The slurry composition of the sixth aspect containing the solids in the above-described ratio can exhibit suitable rheological properties. The slurry composition can thus cure immediately after discharge from the coater. A highly viscous slurry composition is less likely to scatter. Such a slurry composition can advantageously reduce drag at the end of a coating area. Thus, the present invention can provide a slurry composition that can facilitate the application at high coating speed.

According to a seventh aspect, in the slurry composition of the fifth or sixth aspect, the viscosity of the slurry composition is in a range of 0.2 Pa·s to 3 Pa·s when a shear rate of the slurry composition is 1, 000/s, and the range of the viscosity changes from 0.2 Pa·s to 3 Pa·s to 10 Pa·s to 1, 000 Pa·s when the shear rate of the slurry composition is changed from 1,000/s to 0.1/s.

The slurry composition of the seventh aspect can cure immediately after discharge, and can more advantageously reduce drag at the end of a coating area. This can further facilitate the application at high coating speed. In addition, the slurry composition can be discharged more smoothly for high speed coating.

An eighth aspect is directed to a coater for applying a slurry composition to a substrate by the method of any one of the first to fourth aspects. The coater includes: a conveyor that conveys the substrate; and a discharger having an outlet for discharging the slurry composition to the substrate. The outlet has a dimension in a range of 100 mm to 600 mm in a third direction on condition that a direction of a line connecting the discharger and the substrate in the shortest distance is a first direction, a direction orthogonal to the first direction and in which the substrate is conveyed is a second direction, and a direction orthogonal to the first direction and the second direction is the third direction.

The coater of the eighth aspect can reduce a coating defect such as an uneven thickness of the slurry discharged from the coater and an irregular coating surface of the slurry. Thus, the present invention can provide a coater that can facilitate the application at high coating speed.

According to a ninth aspect, in the coater of the eighth aspect, the outlet may have a dimension in a range of 1 mm to 10 mm in the second direction.

The coater of the ninth aspect can further facilitate the application at high coating speed.

The present invention can provide a coating method, a slurry composition, and a coater that are able to facilitate the application at high coating speed.

### BRIEF DESCRIPTION OF THE DRAWINGS

FIG. 1 is a conceptual view illustrating a coating method for applying a slurry composition according to an embodiment. FIG. 2 is a view illustrating the slurry composition applied to a substrate. FIG. 3 is a view illustrating an outlet of a coater and its periphery.

### DETAILED DESCRIPTION OF THE INVENTION

Embodiments of the present invention will be described below. The following embodiments merely exemplify the present invention and do not limit the invention.

### Slurry Composition

The slurry composition of the present embodiment is used to produce a positive electrode of a secondary battery such as a lithium ion battery. The slurry composition contains a positive electrode active material, a conductive agent, a binder, and a solvent.

Examples of the positive electrode active material include layered active materials containing lithium, spinel-type active materials, and olivine-type active materials.

Examples of the conductive agent include acetylene black, carbon nanotubes, graphene, and graphite particles.

Examples of the binder include polyvinylidene fluoride (PVDF), polyvinylidene chloride (PVDC), polyethylene oxide (PEO), polypropylene oxide (PPO), and polyethylene oxide-propylene oxide copolymers.

Examples of the solvent include ester solvents such as butyl butylate.

The slurry composition preferably contains a solid electrolyte.

Any solid electrolyte can be contained as long as it conducts a charge transfer medium, or ions. For example, solid sulfide electrolytes, solid oxide electrolytes, solid nitride electrolytes, and solid halide electrolytes are usable.

Note that the positive electrode active material, the conductive agent, the solid electrolyte, the binder, and the solvent are not limited to the examples described above. For example, the positive electrode active material, the conductive agent, the solid electrolyte, the binder, and the solvent that are similar to those used for general solid-state batteries can be used.

The concentration of solid contents in the slurry composition relative to the total amount of the slurry composition (may be simply referred to as a “solid concentration”) is in a range of 70 mass % to 90 masss, preferably in a range of 75 mass % to 80 mass %.

This can facilitate the application of the slurry composition at high coating speed.

The slurry composition preferably contains 60 mass % to 85 mass % of the positive electrode active material, 1 mass % to 3 mass % of the conductive agent, 10 masss to 38 mass % of the solid electrolyte, and 0.5 mass % to 5 mass % of the binder, relative to the total solid contents in the slurry composition.

More preferably, the slurry composition contains 70 mass % to 85 mass % of the positive electrode active material, 1.5 mass % to 3 mass % of the conductive agent, 10 mass % to 25 mass of the solid electrolyte, and 0.5 mass % to 3 mass % of the binder, relative to the total solid contents in the slurry composition.

This can further facilitate the application of the slurry composition at high coating speed.

The slurry composition preferably has a viscosity in a range of 0.2 Pa·s to 3 Pa·s when a shear rate of the slurry composition is 1,000/s, and the range of the viscosity preferably changes from 0.2 Pa·s to 3 Pa·s to 10 Pa·s to 1,000 Pa·s when the shear rate of the slurry composition is changed from 1,000/s to 0.1/s.

This can further facilitate the application of the slurry composition at high coating speed.

### Coater

The slurry composition of the present embodiment is applied to a substrate 2 using a coater 10, for example. The coater 10 will be described below. A slurry composition 1 is the slurry composition of the present embodiment. The substrate 2 is sheet-shaped. The substrate 2 is a positive electrode current collector and is made of aluminum foil, for example.

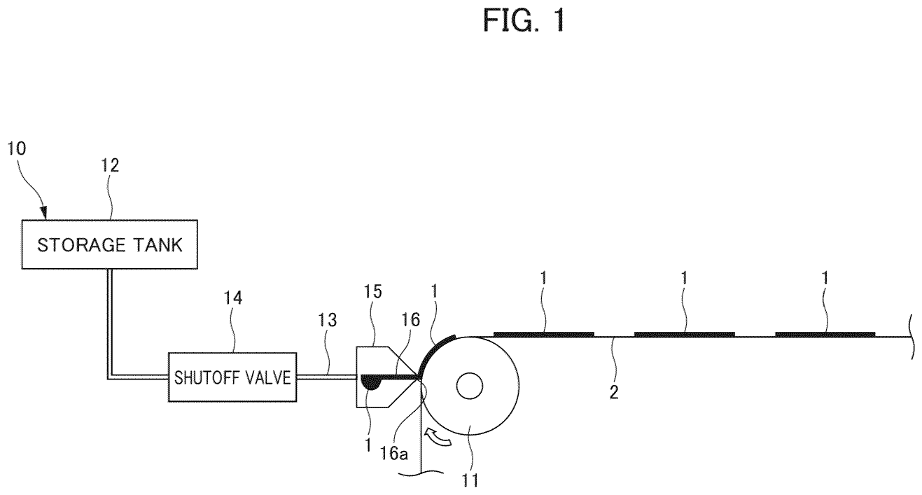

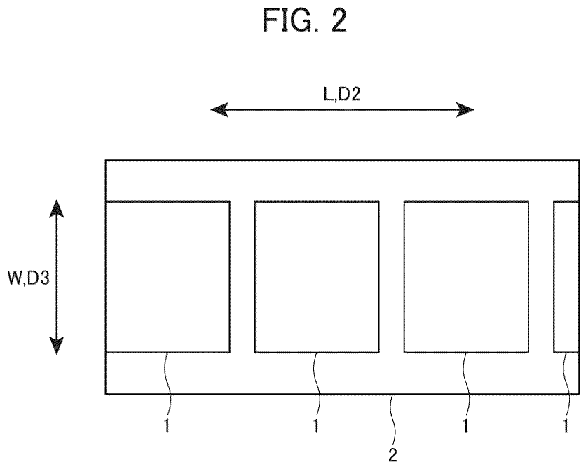

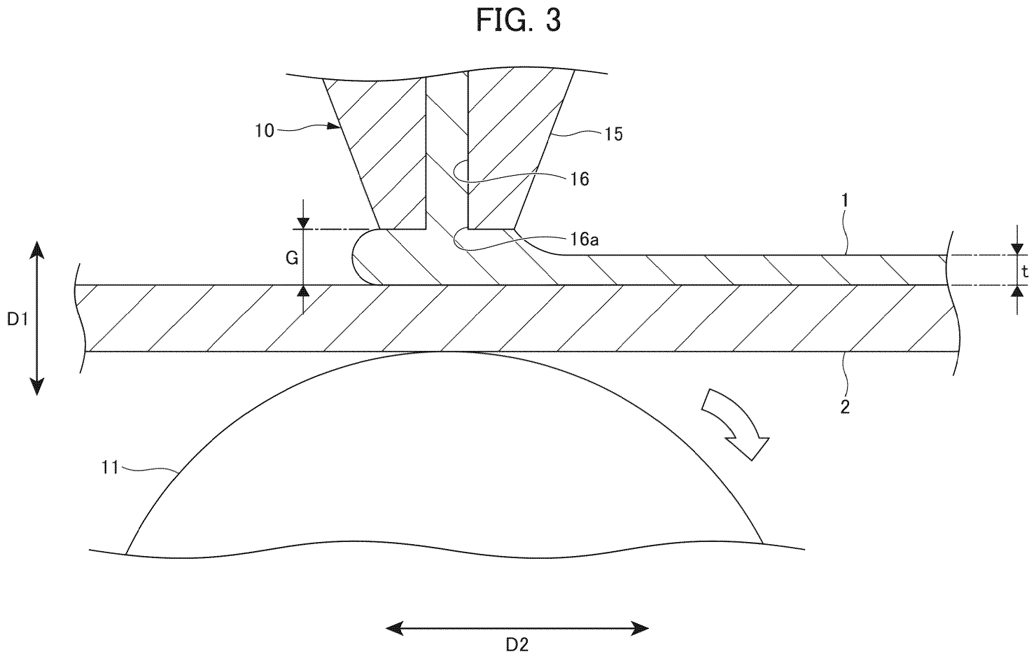

The coater 10 is a device that performs intermittent coating. As shown in FIG. 1, the coater 10 includes a conveyor roller 11, a storage tank 12, a supply path 13, a shutoff valve 14, and a die head 15.

The conveyor roller 11 is a roller that conveys the substrate 2. The conveyor roller 11 is connected to, for example, a motor which is not shown, and is rotated by a driving force of the motor. Rotating the conveyor roller 11 in contact with the substrate 2 conveys the substrate 2. The rotational speed of the conveyor roller 11 (i.e., the rotational speed of the motor) is preferably adjustable. In this case, the conveying speed of the substrate 2 can be adjusted by adjusting the rotational speed of the conveyor roller 11. The conveyor roller 11 corresponds to a conveyor. FIGS. 1 and 3 show a thick arrow indicating the direction of rotation of the conveyor roller.

The storage tank 12 stores the slurry composition.

The supply path 13 is a pipe for feeding the slurry composition. The supply path 13 is connected to the storage tank 12.

The shutoff valve 14 is a switching valve. The shutoff valve 14 is located along the supply path 13. The shutoff valve 14 can be in an allowing state in which the slurry composition 1 can pass through the supply path 13 and a blocking state in which the slurry composition 1 cannot pass through the supply path 13. The shutoff valve 14 is switchable between the allowing state and the blocking state.

The die head 15 is connected to the supply path 13. The storage tank 12 and the die head 15 are connected to each other via the supply path 13. The die head 15 and the conveyor roller 11 are spaced and face each other. While the conveyor roller 11 conveys the substrate 2, a gap is formed between the die head 15 and the substrate 2. When the conveyor roller 11 conveys the substrate 2, the die head 15 and the substrate 2 move relative to each other.

The die head 15 has a channel 16. An end of the channel 16 is connected to the supply path 13. The other end of the channel 16 is open toward the conveyor roller 11. The opening at the other end of the channel 16 will be referred to as an “outlet 16a”. The die head 15 corresponds to a discharger.

A direction of a line connecting the die head 15 and the substrate 2 in the shortest distance will be referred to as a “first direction D1”. A direction orthogonal to the first direction D1 and in which the substrate 2 is conveyed will be referred to as a “second direction D2”. A direction orthogonal to the first direction D1 and the second direction D2 will be referred to as a “third direction D3” (see FIG. 3).

### Coating Method

A coating method for applying the slurry composition of the present embodiment will be described below.

The coating method of the present embodiment includes applying the slurry composition 1 to the substrate 2 by discharging the slurry composition 1 from the outlet 16a of the die head 15 for discharging the slurry composition with the die head 15 and the substrate 2 moving relative to each other.

Specifically, the conveyor roller 11 in contact with the substrate 2 is rotated. Thus, the substrate 2 is continuously conveyed. The die head 15 and the substrate 2 move relative to each other.

When the shutoff valve 14 is in the allowing state, the slurry composition 1 is supplied from the storage tank 12 to the die head 15 through the supply path 13 and discharged from the outlet 16a. While the shutoff valve 14 is in the allowing state, the slurry composition 1 is intermittently discharged from the outlet 16a onto the substrate 2. During the intermittent discharge, the die head 15 and the substrate 2 move relative to each other, providing a section coated with the slurry composition 1 on the substrate 2 continuously in a direction of the relative movement of the die head 15 and the substrate 2.

When the shutoff valve 14 is in the blocking state, the slurry composition 1 cannot pass through the supply path 13 and is not supplied to the die head 15. While the shutoff valve 14 is in the blocking state, the die head 15 stops the discharge of the slurry composition 1. The die head 15 and the substrate 2 move relative to each other at this time, providing a section without the slurry composition 1 on the surface of the substrate 2 continuously in the direction of the relative movement of the die head 15 and the substrate 2.

The shutoff valve 14 is switched between the allowing state and the blocking state while the conveyor roller 11 conveys the substrate 2. Thus, the sections coated with the slurry composition 1 and the sections without the slurry composition 1 are alternately formed on the surface of the substrate 2 in the direction of the relative movement of the die head 15 and the substrate 2. In other words, the slurry composition 1 is intermittently applied to the substrate 2.

As shown in FIG. 2, multiple coatings of the slurry composition 1 are arranged at intervals on the surface of the substrate 2 that has undergone the application of the slurry composition 1. Among the directions parallel to the surface of the substrate 2, the direction in which the coatings of the slurry composition 1 are arranged will be referred to as a “length direction L”, and a direction orthogonal to the length direction L will be referred to as a “width direction W”. The length direction L is the second direction D2 for the application, and the width direction W is the third direction D3 for the application. Each of the coatings of the slurry composition 1 is rectangular. Each coating of the slurry composition 1 has substantially the same dimension in the width direction W as the dimension of the outlet 16a in the second direction D2.

The coating of the slurry composition 1 is dried to be a positive electrode. Although not described in detail, the substrate 2 coated with the slurry composition 1 is further processed into an electrode sheet for a secondary battery.

The substrate is conveyed at the same speed as the coating speed of the slurry composition. The slurry composition may be applied at any speed, but preferably at higher speed for speeding up of the production of the secondary battery.

When the slurry is applied at high speed, there is concern that a coating defect may occur, such as an uneven thickness of the slurry discharged from the coater and an irregular coating surface of the slurry. Further, the slurry may remain (as a “lump”) on the side of the end of the die head 15 opposite to the conveying direction of the substrate. The lump formed on the die head 15 may easily cause a coating defect.

Then, a capillary number Ca is obtained by dividing a product of a viscosity (Pa·s, represented by symbol “μ”) and coating speed (m/s, represented by symbol “U”) of the slurry composition by a surface tension (N·m, represented by symbol “σ”) of the slurry composition. That is, capillary number Ca=μ×U/σ is met.

The capillary number Ca is in a range of one to five.

As shown in FIG. 3, the thickness (mm) of the coating of the slurry composition 1 will be referred to as a “coating thickness t”. A distance (mm) between the die head 15 and the substrate 2 will be referred to as a “bead gap G”.

A value obtained by dividing the coating thickness t by the bead gap G is greater than ⅔ and less than one.

When the slurry composition according to the present embodiment is applied by the coating method, a coating defect such as an uneven thickness of the slurry discharged from the coater and an irregular coating surface can be reduced. This can facilitate the application of the slurry composition at high coating speed.

The bead gap G is preferably greater than 200 μm and less than 300 μm.

The coating thickness t is preferably in a range of 100 μm to 200 μm.

The value U is preferably in a range of 0.83 m/s to 1.17 m/s.

Setting the values within these ranges can further facilitate the application of the slurry composition at high coating speed.

The outlet 16a of the coater 10 is, for example, an opening in the shape of a slit which is long in the second direction D2. The outlet 16a preferably has a dimension in a range of 100 mm to 600 mm in the third direction D3.

The outlet 16a preferably has a dimension in a range of 1 mm to 10 mm in the second direction D2.

Setting the values within these ranges can further facilitate the application of the slurry composition at high coating speed.

### EXAMPLES

Examples of the present invention will be described below, but the present invention is not limited to these examples.

### Preparation of Slurry Composition

The slurry composition of the embodiment was prepared as samples of Examples 1 and 2 and Comparative Examples 1 to 6. The samples of Examples and Comparative Examples were the same.

The slurry composition was prepared by kneading a mixture of a positive electrode active material, a conductive agent, a solid electrolyte, a binder, and a solvent.

A ternary positive electrode material was used as the positive electrode active material. The slurry composition contained 60 mass % to 85 mass %, more specifically, 80.0 mass %, of the positive electrode active material relative to the total solid contents in the slurry composition. Acetylene black was used as the conductive agent. The slurry composition contained 1 mass % to 3 mass %, more specifically, 1.92 mass %, of the conductive agent relative to the total solid contents in the slurry composition. A sulfide-based solid electrolyte was used as the solid electrolyte.

The slurry composition contained 10 mass % to 38 mass %, more specifically, 15.5 mass %, of the solid electrolyte relative to the total solid contents in the slurry composition. Polyvinylidene fluoride (PVDF) was used as the binder. The slurry composition contained 0.5 mass % to 5 mass %, more specifically, 2.56 mass %, of the binder relative to the total solid contents in the slurry composition.

Butyl butylate was used as the solvent. The solid concentration was 70 mass % to 90 mass %, more specifically, 79.4 mass %.

### Test Method

The slurry composition was applied using the coater 10 of the embodiment. The coating of the slurry composition 1 applied to the substrate 2 had a dimension of 500 mm in the width direction W (i.e., the dimension of the outlet 16a in the second direction D2). The slurry composition was applied at a coating speed of 60 m/min. The coating speed was set for so-called high speed coating.

A value obtained by dividing the coating thickness t by the bead gap G and the capillary number Ca were varied for each sample of Examples and Comparative Examples. Table 1 shows the coating thickness t, the bead gap G, and the value obtained by dividing the coating thickness t by the bead gap G, and the capillary number Ca for each sample of Examples and Comparative Examples.

The ease of application was evaluated for each sample of Examples and Comparative Examples. The sample was rated “good” if no defects were found in the application of the slurry composition, and was rated “not good” if any defect was found. Examples of the defects in the application include an irregular coating surface of the slurry composition, crack in the coating surface of the slurry composition, and a lump of the slurry formed on the die head 15. Table 1 shows the evaluation results of Examples and Comparative Examples.

TABLE 1

| | Comparative | Comparative | | | | | | |
|---|---|---|---|---|---|---|---|---|
| | Example 1 | Example 2 | Example 1 | Example 2 | Example 3 | Example 4 | Example 5 | Example 6 |
| COATING THICKNESS t(mm) | 200 | 200 | 200 | 200 | 200 | 200 | 200 | 200 |
| BEAD GAP G(mm) | 200 | 200 | 250 | 250 | 300 | 300 | 400 | 500 |
| COATING THICKNESS t/ | 1 | 1 | 4/5 | 4/5 | 2/3 | 2/3 | 1/2 | 2/5 |
| BEAD GAP G | | | | | | | | |
| CAPILLARY NUMBER Ca | 2 | 5 | 2 | 5 | 2 | 5 | 2 | 5 |
| RATING | NOT GOOD | NOT GOOD | GOOD | GOOD | NOT GOOD | NOT GOOD | NOT GOOD | NOT GOOD |

### Results

In the samples of Examples 1 and 2, the coating surface was not irregular or cracked, and no lump was formed. In the samples of Comparative Examples 1 and 2, a lump was formed. In the samples of Comparative Examples 3 and 4, the coating surface was irregular. In the samples of Comparative Examples 5 and 6, the coating surface was cracked. The samples of Examples 1 and 2 were confirmed to be good in terms of ease of application in high speed coating. The samples of Comparative Examples 1 and 6 were not confirmed to be good in terms of ease of application in high speed coating.

### EXPLANATION OF REFERENCE NUMERALS

1: Slurry composition, 10: Coater, 11: Conveyor roller as a conveyor, 15: Die head as a discharger, 16a: Outlet

What is claimed is:

1. A coating method for applying a slurry composition containing a positive electrode active material, a conductive agent, a binder, and a solvent, the method comprising:
applying the slurry composition to a substrate by discharging the slurry composition from an outlet of a discharger for discharging the slurry composition with the discharger and the substrate moving relative to each other, wherein
a concentration of solid contents relative to a total amount of the slurry composition is in a range of 70 mass % to 90 mass %,
a capillary number obtained by dividing a product of a viscosity (Pa·s) and coating speed (m/s) of the slurry composition by a surface tension (N·m) of the slurry composition is in a range of one to five, and a value obtained by dividing a coating thickness of the slurry composition by a bead gap which is a distance between the outlet and the substrate is greater than ⅔ and less than one.

2. The coating method according to claim 1, wherein the bead gap is greater than 200 μm and less than 300 μm.

3. The coating method according to claim 1, wherein the coating thickness is in a range of 100 μm to 200 μm.

4. The coating method according to claim 1, wherein the coating speed of the slurry composition is in a range of 0.83 m/s to 1.17 m/s.

5. The slurry composition used in the method according to claim 1, wherein the slurry composition contains a solid electrolyte.

6. The slurry composition according to claim 5, wherein the slurry composition contains 60 mass % to 85 mass % of the positive electrode active material, 1 mass % to 3 mass % of the conductive agent, 10 mass % to 38 mass % of the solid electrolyte, and 0.5 mass % to 5 mass % of the binder, relative to a total solid contents in the slurry composition.

7. The slurry composition according to claim 6, wherein a viscosity of the slurry composition is in a range of 0.2 Pa·s to 3 Pa·s when a shear rate of the slurry composition is 1, 000/s, and a range of the viscosity changes from 0.2 Pa·s to 3 Pa·s to 10 Pa·s to 1, 000 Pa·s when the shear rate of the slurry composition is changed from 1,000/s to 0.1/s.

8. A coater for applying a slurry composition by the coating method according to claim 1, the coater comprising:
a conveyor that conveys the substrate; and
a discharger having an outlet for discharging the slurry composition to the substrate,
wherein
the outlet has a dimension in a range of 100 mm to 600 mm in a third direction on condition that a direction of a line connecting the discharger and the substrate in the shortest distance is a first direction, a direction orthogonal to the first direction and in which the substrate is conveyed is a second direction, and a direction orthogonal to the first direction and the second direction is the third direction.

9. The coater according to claim 8, wherein the outlet has a dimension in a range of 1 mm to 10 mm in the second direction.
